(19) United States
(12) Patent Application Publication
(10) Pub. No.: US 2004/0092681 A1
(43) Pub. Date: May 13, 2004

(54) Use of supported heat-stable chromium hydride species for olefin polymerization

(76) Inventors: Anne Baudouin, Lyon (FR); Jean Thivolle-Cazat, Fontaines (FR); Jean-Marie Basset, Caluire (FR)

Correspondence Address: YOUNG & THOMPSON, 745 SOUTH 23RD STREET 2ND FLOOR, ARLINGTON, VA, 22202

(21) Appl. No.: 10/380,834

(22) PCT Filed: Sep. 21, 2001
(86) PCT No.: PCT/FR01/02947

(30) Foreign Application Priority Data
Sep. 22, 2000 (FR) 00/12120

(51) Int. Cl. C08F 4/44

(52) U.S. Cl. 526/129; 526/90; 526/160; 526/943; 526/352

(57) ABSTRACT

A method of controlling the molecular weight distribution of a polyalpha-olefin during polymerization, comprising changing the aluminoxane to chromium ratio of a polymerization catalyst comprising chromium and at least one aluminoxane to thereby adjust the molecular weight distribution.

The present invention relates to the use of supported chromium hydride entities for carrying out the polymerization of olefins.

Chromium-based heterogeneous catalysts are widely used in industry to polymerize α-olefins and in particular ethylene. The two processes which are most widely used industrially are the “Phillips” process and the “Union Carbide” process. However, generally, the structures of these catalysts are poorly known, and the active sites, which can be of numerous types, generally represent only a small part of the grafted metal. The percentage of active metal typically ranges from 0.01 to 10% (Mc Daniel, Adv. Catal., 1985, Vol. 33, 47-98) (Hogan, J. Polym. Sci. A, 1970, Vol. 8, 2637-2652). Although studies have been carried out to determine the exact nature of the interactions between the metal entities and the support, the active systems in heterogeneous polymerization generally remain extremely poorly characterized, in particular in the case of the currently known chromium-based heterogeneous catalysts, which presents in particular problems of optimization and of control with regard to their effectiveness.

Thus, the exact structures of the two most common chromium-based catalysts for the polymerization of olefins, namely the catalyst known as the “Phillips catalyst” (CrO₃ supported on silica) and the catalyst known as the “Union Carbide catalyst” (CrCp₂ on silica support), are not known, nor is the nature of the active entities employed in the reaction for the polymerization of olefins. In fact, the nature and in particular the degree of oxidation of the chromium in these catalysts are still subject to controversy. In particular, whatever the degree of oxidation, (II) or (VI), of the precursor, authors have proposed every degree of oxidation between (II) and (V) for the active site. Recently, S. L. Scott et al. have proposed that this active entity is a chromium carbene bonded to the silica via two covalent bonds ≡Si—O—Cr (JACS, 1998, Vol. 120, p. 415-416).

In point of fact, the inventors have now discovered that chromium hydride entities, identifiable as such, supported on a solid support, and in particular chromium(IV) hydride entities, are active in the polymerization of olefins.

In addition, the studies of the inventors have also allowed it to be demonstrated that the preparation of chromium hydrides by reaction of hydrogen with chromium-based entities grafted to a support generally, in particular in the case of starting entities based on chromium(IV), results in the production of a single-site catalyst, that is to say of a heterogeneous catalyst, on the surface of which the metal entities present are essentially all of the same nature.

Surprisingly, the inventors have also discovered that, contrary to the other heterogeneous catalysts for the polymerization of olefins, and in particular in comparison with the other catalysts based on metal hydrides, these supported chromium hydride entities generally exhibit a thermal stability which allows them to be used within a very wide temperature range.

On the basis of these discoveries, one of the aims of the invention is to provide a heterogeneous catalyst for the polymerization of olefins, and in particular of ethylene, exhibiting a high activity.

Another aim of the invention is to make it possible to carry out reactions for the polymerization of olefins which are effective over a wide temperature range, in particular so as to be able to carry out the polymerization of large olefins, or to carry out reactions for the copolymerization of olefins exhibiting very different sizes and/or exhibiting functional groups.

Furthermore, another aim of the invention is to provide a process for the polymerization of olefins which makes it possible, inter alia, to vary the structure of the polymers obtained (size, presence and degree of branchings, and the like).

Thus, according to a first aspect, a subject matter of the present invention is the use of a catalyst composed of chromium hydride entities identifiable as such, which entities are bonded to the surface of an inorganic support and are thermally stable at 400° C., for carrying out the polymerization of olefins.

The term “polymerization” will be understood as meaning, within the meaning of the invention, any reaction for the condensation of at least two monomer units. Thus, the term “polymerization” within the meaning of the invention covers in particular dimerizations, trimerizations and oligomerizations, as well as polymerization reactions within the commonest meaning of the term. The polymerizations according to the invention can also be copolymerizations, that is to say condensations of monomer units of different natures.

The term “chromium hydride entities identifiable as such” will be understood as meaning, within the meaning of the invention, in particular in contrast to a chromium hydride entity acting as reaction intermediate, any supported chromium hydride entity with a sufficient lifetime to be able to be characterized in infrared spectrometry by the presence of a peak characteristic of a Cr—H bond which disappears or weakens when this entity is brought into the presence of deuterium, bringing about the appearance of another peak characteristic of a Cr-D bond.

The values corresponding to these peaks on an infrared spectrogram are capable of varying within a fairly wide range according to the support employed. However, in the most general case, the peak characteristic of a silica-supported Cr—H bond may be regarded as situated in the vicinity of 2110 cm⁻¹ and that of a supported Cr-D bond may be regarded as situated at approximately 1550 cm⁻¹.

The supported chromium hydride entities which constitute the catalyst of the invention are specifically entities which are thermally stable at 400° C., namely, within the meaning of the present invention, supported chromium hydride entities exhibiting a thermal stability such that, if these supported entities are placed at a temperature of 400° C. for one hour and under an inert atmosphere (in particular under argon or under nitrogen), the area of the peak characteristic of the Cr—H bond observed in fine in infrared spectrometry is at least equal to 30% of the area of the peak characteristic of the Cr—H bond observed before the heat treatment. Advantageously, this area of the peak characteristic of the Cr—H bond observed in fine (which reflects, treated as a whole, the amount of chromium hydride entities remaining after the heat treatment) is at least equal to 40% of the area of the peak initially observed and it can reach at least 50%, indeed even at least 60%, of this initial area. Generally, the supported chromium hydride entities of the working catalyst according to the invention are thermally stable under an inert atmosphere and for several hours up to a temperature of 400° C. Thus, if the catalyst of the invention is subjected to a heat treatment at 400° C. and under an inert atmosphere for a prolonged period of time, the area of the peak characteristic of the Cr—H bond observed in infrared spectrometry generally remains at least equal to 30% of the value of the area of the peak characteristic of the Cr—H bond observed before the heat treatment (and advantageously remains at least equal to 40% of this value, indeed even to 50% of this value, in some cases) for a period of time of at least two hours, generally for a period of time of at least four hours, and preferably for a period of time of greater than or equal to six hours, indeed even greater than or equal to 12 hours. Furthermore, it should be noted that, following a heat treatment at 400° C. and under an inert atmosphere for 12 hours, the area of the peak characteristic of the Cr—H bond observed in infrared spectrometry generally remains substantially stable if the heat treatment is continued (or if it is repeated) at 400° C. and under an inert atmosphere.

The thermal stability of the supported chromium hydride entities constituting the working catalyst according to the invention is particularly advantageous insofar as it renders possible the use of this catalyst at high temperatures, which are generally required for the polymerization of olefins with high molecular masses, indeed even of functionalized monomers. It should be noted that, with complexes based on a metal from Group IV of titanium, zirconium and hafnium type, V of vanadium, niobium or tantalum type or VI of molybdenum or tungsten type, this type of polymerization of olefins of high molecular weight cannot be envisaged since their thermal stability never exceeds 200° C.

In contrast to the conventional chromium-based catalysts of the type of those mentioned above, the working catalysts according to the invention additionally exhibit the marked advantage of having a very high number of active chromium sites.

Thus it is that the supported chromium hydride entities of the catalyst employed according to the invention represent, in the most general case, at least 10%, advantageously at least 50% and, in a particularly preferred way, at least 80% of the chromium-based entities present at the surface of the inorganic support. The conventional chromium catalysts generally have less than 10% of active sites (vide supra).

According to a particularly advantageous alternative form of the invention, the catalyst employed is a catalyst of single-site type, that is to say at the surface of which the chromium-based entities are essentially all chromium hydrides of identical nature. More generally, the chromium hydride entities present at the surface of the catalyst can be chromium(II), (III), (IV) or (V) hydride entities. Advantageously, they are chromium(III) or (IV) hydride entities and more preferably chromium(IV) hydride entities. The exact nature of the chromium hydrides present at the surface of the catalyst can depend in particular on the inorganic support used.

Furthermore, the activity and the selectivity of these catalysts can be varied by the presence or the absence, in the coordination sphere of the chromium, of specific ligands of Lewis base or acid type, for example. Ligands of this type, which affect the electrophilicity or the steric environment of the metal, are thus involved in the activity of said catalyst and thus make it possible to vary, for example, the rate of polymerization correlated with the parameters of initiation, of propagation, of termination and/or of chain transfer.

As regards the inorganic support, it can be selected from any support conventionally employed in heterogeneous catalyses for the polymerization of olefins. Thus, the support used is generally provided in the form of a finely divided solid exhibiting a high specific surface area and generally comprising at least one metal oxide. Advantageously, it is composed of silica, of alumina, of niobium oxide or of silica/alumina. In a particularly preferred way, it is composed of silica. It can also be composed of a zeolite, of a mesoporous oxide or of a natural clay, this list being in no way limiting.

It is understood that the nature of the support also plays an important role with regard to the activity of the active entity. Just like the chromium ligands mentioned above, the support can, by its nature, affect the electrophilic nature of the chromium and in particular can increase the latter.

The chromium hydride entities present at the surface of the catalyst are advantageously in the form of supported hydrides corresponding to the following general formula (A):

(support)ₙ-Cr—(H)ₘ (A)

in which:

n represents an integer equal to 1, 2, 3 or 4 and preferably equal to 3,

m represents an integer equal to 1, 2 or 3, with the sum of m and n being less than or equal to 6 and preferably equal to 4.

More preferably, the chromium hydride entities present at the surface of the silica are essentially and preferably in the form of chromium(IV) hydride of formula: (support)₃-Cr—H, where the support is preferably silica.

In the most general case, and whatever the exact nature of the supports employed, the chromium hydride entities present at the surface of the catalyst can be obtained by treatment using hydrogen or a hydrogen or alkyl transfer agent, such as silane, tin hydride, borane, alkylaluminum and aluminum hydride, of the chromium-based entities adsorbed beforehand on the support. The treatment of these entities by hydrogen is generally carried out at a temperature of between 25 and 500° C. and under a hydrogen pressure of between 10⁴ Pa and 10⁷ Pa, these various parameters naturally having to be adapted according to the support employed and the chemical nature of the adsorbed chromium-based entities.

The chromium entities attached to the surface of the support and which have to result in the active hydride entities generally correspond to the following general form (B):

(support)_{n1-Cr(X)}ₙ₂ (B)

in which:

n1 and n2 are two non-zero integers such that the sum (n1+n2) is equal to 2, 3, 4, 5 or 6, preferably equal to 4,

X represents a C₁-C₈ alkyl, C₁-C₈ alkylsilyl, C₁-C₈ allyl or silyl group, a carbonyl, amide, carbene, carbyne, carboxylate, acetylacetonate (acac) or imido derivative, a cyclopentadienyl, neophyl, benzyl, phenyl, oxo, alkoxide, phosphine, nitrosyl or —CH₂(CPhMe₂) group, the alkoxide group optionally comprising a silicon atom, or a metal selected from chromium, molybdenum, tungsten or one of their derivatives.

More preferably, X represents a C₁-C₈ alkyl group, a C₁-C₈ alkylsilyl group, a C₁-C₈ allyl group, a cyclopentadienyl group, a carbene group or a carbyne group.

To attach the entities to the support under consideration, the molecular precursor under consideration of the chromium, that is to say having one or more ligands as defined above for X, is generally reacted, either in the gas phase or in the liquid phase, with the support surface under consideration.

In the specific context of a silica-based support, the chromium hydride entities present at the surface of the catalyst can be obtained by hydrogenolysis of the entities supported on silica.

In this specific case, the silica employed is advantageously subjected to a preliminary stage of thermal dehydroxylation, preferably at a temperature of between 200° C. and 1600° C., and particularly advantageously at a temperature of between 200° C. and 700° C., and for a period of time generally of between 1 and 100 hours.

Advantageously, in the formula (B), the X group represents a methyl(trimethylsilyl) (—CH₂Si(CH₃)₃) group.

Thus, a working catalyst according to the invention can advantageously be obtained by hydrogenolysis of tris[(methyl(trimethylsilyl)]chromium(IV) entities supported on silica, of formula:

(≡Si—O—)Cr(CH₂Si(CH₃)₃)₃.

In the specific case of the hydrogenolysis of tris[methyl(trimethylsilyl)]chromium(IV) entities supported on silica, in particular so as to obtain a catalyst of single-site type where essentially all the chromium-based entities at the surface of the catalyst are chromium(IV) hydrides of formula (silica-)₃-Cr—H, the temperature during the hydrogenolysis is advantageously between 150° and 250° C.

The catalysts used according to the invention are advantageously employed in carrying out the polymerization of α-olefins, such as ethylene. In the case of ethylene in particular, their use generally results in the production of more or less branched polyolefins, which use can be taken advantage of in particular in synthesizing a polyethylene with variable branching.

This is because the inventors have demonstrated that the use of supported chromium hydride entities leads, during the polymerization of α-olefins, to oligomerization reactions of dimerization or trimerization type. The short oligomers of dimer or trimer type obtained in situ are then capable of resulting in copolymerization reactions with the monomer initially introduced, which then generally results in the production of short branchings on the polymer chains. This type of reaction, leading to the formation of branchings, is particularly marked in the case of the polymerization of ethylene.

In the context of the present invention, this monomer can also be functionalized and can take part in a copolymerization, resulting in a functionalized polymer.

Mention may in particular be made, as examples of functional olefins, of olefins comprising groups of ester, acrylate, methacrylate, acid, nitrile, amide and/or anhydride type. Of course, these groups have to be compatible with the claimed process. A person skilled in the art is in a position to adjust the operating parameters in order to prevent them from reacting under the reaction conditions.

In view of the high thermal stability of the supported chromium hydride entities, in particular of the entities supported on silica, the working catalysts according to the invention advantageously make it possible to carry out reactions for the polymerization of relatively large olefin monomers which can have up to 100 carbon atoms.

The studies of the inventors have also made it possible to demonstrate that the working catalysts according to the invention generally exhibit, in addition to a high thermal stability, a wide temperature range within which they are active in the polymerization of olefins. Thus, in the specific context of a silica-based support, and in particular in the case where the chromium hydride entities are essentially entities of formula (silica-)₃-Cr—H, the catalyst can be employed at a temperature of between −20° C. and 400° C. while exhibiting an advantageous catalytic activity. This wide temperature range for potential use of the catalysts of the invention makes it possible in particular to vary the characteristics of the polymers obtained in fine. Another advantage of this very wide temperature range is that it makes it possible to copolymerize a nonfunctional monomer with a functional monomer: this can only be envisaged at high temperatures because of the deactivation of the double bond by the functional group. Acrylates are particularly attractive comonomers which it is exactly impossible to copolymerize with α-olefins by the conventional routes of Ziegler catalysis.

On the basis of the various advantages set out above, another subject matter of the invention is, according to a second aspect, a process for the polymerization of olefins. This process comprises a stage in which olefin monomers are brought into contact with a catalyst comprising chromium hydride entities identifiable as such, which entities are bonded to the surface of an inorganic support and are thermally stable at 400° C.

Advantageously, the catalyst employed in this process is a catalyst based on chromium hydride as defined above and preferably a catalyst in which the inorganic support is silica. In a particularly advantageous way, the catalysts employed is a catalyst of single-site type where essentially all the chromium-based entities present at the surface are chromium hydride entities of identical nature and preferably chromium(IV) hydrides.

Thus, in a particularly advantageous way, the catalyst employed in the process of the invention is a catalyst of single-site type supported on silica in which the chromium-based entities present at the surface are essentially all chromium(IV) hydride entities of formula (silica-)₃-Cr—H.

According to a first embodiment, the polymerization process of the invention can be carried out by bringing the catalyst and a gas stream of the olefin monomers directly into contact.

If appropriate, the catalyst is generally subjected to significant mechanical agitation in a reactor of fluidized bed type, so as to optimize the surface area for exchange with the olefins. The olefins in the gas state are then generally employed at a pressure of between 10⁴ Pa and 10⁷ Pa. The polymerization reaction is generally carried out at a temperature of between −20° C. and 400° C., this temperature having to be adjusted on a case by case basis, in particular according to the thermal stability of the catalyst, the molecular weights of the olefins employed and the structures desired for the polyolefins synthesized in fine.

According to a second embodiment, the catalyst can be suspended in a solvent. The olefin monomers are then employed in the form of a gas bed at the surface of the solvent comprising the catalyst, which is subjected to significant mechanical agitation so as to keep the catalyst in suspension.

The nature of the solvent employed has to be adjusted, in particular, to the nature of the olefins which it is desired to polymerize and of the catalyst employed. However, in the general case, the solvent is preferably selected from aliphatic hydrocarbons, such as heptane, or aromatic hydrocarbons.

The temperature at which the polymerization reaction according to this second embodiment is carried out depends not only on the thermal stability of the catalyst used, on the molecular weights of the olefin monomers and on the structures desired for the polymers synthesized but also on the nature of the solvent employed.

Whatever the exact method of bringing the olefin monomers and the catalyst into contact, the process of the invention can, if need be, be carried out in the presence of hydrogen. This is because the presence of hydrogen makes it possible in particular to vary the structure of the polymer obtained (degree of branchings, distribution of the molecular masses) and, in some cases, to improve the activity of the catalyst.

In the case of the polymerization or copolymerization of olefins which exhibit from 2 to 10 carbon atoms and which are, if appropriate, functionalized, the temperature at which the process of the invention is carried out can generally be between −20° C. and 400° C.

In particular, the inventors have shown that the use of supported chromium hydrides identifiable as such makes it possible to carry out the polymerization of light olefins of this type at relatively low temperatures, that is to say at temperatures of between −20° C. and 100° C. At 20° C., the other polymerization catalysts are generally inactive or only slightly active. However, it should be noted that the light olefins employed at these low temperatures are preferably α-olefins and that they advantageously have less than 8 carbon atoms and, in a particularly preferred way, less than 6 carbon atoms. Thus, they are preferably ethylene, propylene, 1-butene, 1-hexene or their mixtures.

The process of the invention is also suited to the polymerization of larger olefins, in particular to the polymerization of olefins, preferably α-olefins, which have from 10 to 100 carbon atoms and which are, if appropriate, functionalized. In this case, however, the temperature for carrying out the process has to be higher than in the case of olefins of low molecular weight.

Thus, in the case of the polymerization of heavy olefins of this type comprising from 10 to 100 carbon atoms, the polymerization reaction is preferably carried out at a temperature which can reach up to 400° C.

At such temperatures, these olefins can be employed with smaller olefins, such as α-olefins having from 2 to 10 and preferably from 2 to 4 carbon atoms, such as, for example, ethylene or propylene, so as to result in copolymerization reactions of large olefins and of olefins of low molecular weight. In this case, the olefins employed are composed of a mixture of olefins generally comprising at least one olefin having from 2 to 10 carbon atoms and at least one olefin comprising from 10 to 100 carbon atoms. It is also possible to envisage the polymerization of a mixture of olefins comprising at least one olefin having from 2 to 10 carbon atoms and at least one functional olefin exhibiting one or more functional groups of acrylate, methacrylate, nitrile, ester, amide and/or anhydride type.

As regards the thermal stability of the catalysts used according to the invention, it should be noted that this stability is generally such that the catalyst can be regenerated on conclusion of the polymerization reaction by the action of a stream of hydrogen at high temperature, generally of the order of 200° C. The regeneration of the catalyst can be observed by acquisition of an infrared spectrum. This is because, on conclusion of the treatment with hydrogen, the regenerated catalyst again exhibits the peak characteristic of the Cr—H bond, which disappears during the formation of the entities for propagation of the polymerization reaction. During the polymerization, the EPR spectrum of the solid, which demonstrates the presence of chromium(IV), is still present with the same intensity. The catalyst does not change in degree of oxidation during the polymerization. These factors imply that chromium(IV) is indeed the active entity and that it is converted under olefin to a Cr-polymer entity.

The advantages and characteristics of the working catalysts according to the invention and of the processes employing them will become even more clearly apparent in the light of the FIGURE and of the non-limiting examples set out below.

### FIGURE

FIG. 1: Electron paramagnetic resonance spectrum of chromium(IV) hydride entities on silica (silica-)₃-Cr—H, recorded at −196° C.

### EXAMPLE 1

### Preparation of a Catalyst Based on Chromium(IV) Hydride Entities Supported on Silica

1.a. Preparation of the Catalyst in the Form of Infrared pellets.

The first synthesis of this hydride was carried out in an IR cell. This is because a pyrex cell equipped with windows made of calcium fluoride CaF₂ makes possible the acquisition of infrared spectra in situ. On the one hand, a silica pellet weighing approximately 20 mg is introduced into this reactor and, on the other hand, a pigtail comprising an organometallic precursor Cr(CH₂Si(CH₃)₃)₄ is tightly attached at the side. Once the heat treatment of the silica has been carried out (typically 15 hours at 500° C. under 10⁻⁵ torr), the pigtail is broken, so as to sublime the organometallic precursor onto the silica, still under vacuum at 10⁻⁵ torr: a single tris(trimethylsilylmethyl)chromium(IV) entity supported on silica is obtained.

After desorption of the possible excess molecular complex, hydrogen is introduced under a pressure of 10⁵ Pa and reaction is allowed to take place at a temperature of 150° C. for 15 h.

The surface chromium hydride entity was characterized by the following techniques:

infrared spectroscopy: a band at 2110 cm⁻¹, characteristic of a supported Cr—H bond, is observed. By reaction of the catalyst obtained with deuterium gas at a temperature of 25° C., it is recorded that the band at 2110 cm⁻¹ observed above disappears to the advantage of a new band at 1553 cm⁻¹, characteristic of a Cr-D bond. Under hydrogen, the Cr—H band reappears at 2110 cm⁻¹.

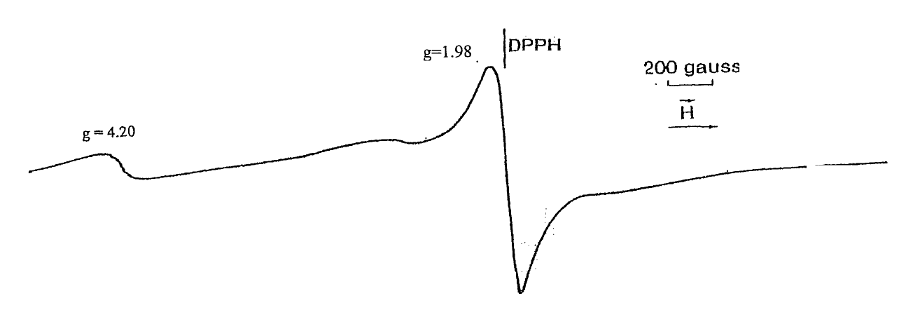

Electron paramagnetic resonance (EPR): an EPR analysis shows that all the chromium present at the surface of the silica is at the +IV degree of oxidation (FIG. 1).

Furthermore, quantitative determination of the hydrides present by reaction with CH₃I (exclusive evolution of one equivalent of methane) or with CH₃OH (exclusive evolution of one equivalent of hydrogen) shows that there is one hydride per surface chromium.

In view of the various factors revealed by the analysis, it therefore transpires that the structure of the chromium hydride synthesized is as follows:

(silica-)₃-Cr—H

1.b. Preparation of the Catalyst in the powder Form

A few grams of silica, dehydroxylated beforehand at 500° C. in a similar way to example 1.a, and one equivalent, with respect to the surface silanol groups, of organometallic precursor Cr(CH₂Si(CH₃)₃)₄ are weighed out in a glass reactor in a glovebox. Treatment under vacuum at ambient temperature for 5 h, followed by desorption at 50° C. for 1 h, makes it possible to obtain the tris(trimethylsilylmethyl)chromium(IV) entity supported on silica. Treatment under hydrogen analogous to that of example 1.a makes it possible to obtain the surface hydride entity exhibiting the same spectroscopic and analytical characteristics as that of example 1.a.

### EXAMPLE 2

### Polymerization of Ethylene in the Gas Phase Under Ethylene Pressure and Using a Catalyst Based on Chromium(IV) Hydride Entities Supported on Silica

A catalyst obtained according to a process similar to that of example 1.b was employed in carrying out the polymerization of ethylene at a temperature of 100° C., the ethylene being introduced in the gas form, with an ethylene pressure equal to 10⁶ Pa (10 bar).

The activity observed after a reaction time of 1 hour is 90 kg of polymer per mole of chromium.

### EXAMPLE 3

### Polymerization of Ethylene with a Catalyst Based on Chromium Hydride Entities Supported on Silica, in Suspension in Heptane

50 mg of a catalyst obtained according to a similar process to that of example 1.b were suspended with mechanical stirring in a volume of 300 ml of heptane in a glass reactor. The temperature of the medium was brought to 100° C.

Ethylene was then introduced at a pressure of 5×10⁵ Pa and at a temperature of 100° C. in the form of a gas bed at the surface of the heptane, and the polymerization reaction was allowed to initiate and to continue for 1 hour. The reaction is carried out in the presence of triethylaluminum (5 eq.) as purifying agent.

The activity observed for the catalyst is 15 kg of polymer per mole of chromium employed.

### EXAMPLE 4

### Demonstration of the Single-Site Nature of the Catalyst

The catalyst synthesized in example 1.a was left in the pyrex infrared cell, which makes it possible to introduce olefins in the liquid form or in the gas form and to monitor by infrared spectroscopy the formation of the products and the disappearance of the reactants.

Ethylene in the gas state is introduced into the cell, in the presence of said catalyst, under a reduced pressure equal to 250 millibar (25 kPa) and at a temperature T. An immediate disappearance of the absorption band at 2110 cm⁻¹, characteristic of the Cr—H bond of the surface hydride, and the appearance of C—H and C—C stretching and bending bands, corresponding to the formation of polyethylene, were observed in the infrared spectra obtained.

By way of comparison, the catalysts of Phillips type (CrO₃ supported on silica) in the literature are inactive in polymerization at these processing temperatures and at this ethylene pressure.

Analysis by gas chromatography (GC) and by gas chromatography coupled to mass spectrometry (GC/MS) of the gas phase during the polymerization reaction shows that, at a temperature T of 20° C. and after a reaction time of 1 hour, the reaction medium also comprises ethylene dimers and trimers (1-butene: approximately 1 mol %, and 1-hexene: approximately 3 mol %).

When the reaction is carried out at a temperature of 100° C. with the additional presence of hydrogen gas under a relative pressure of 50 millibar (5 kPa), the polymerization reaction is 5 times faster than at 100° C. in the absence of hydrogen.

1. Use of a catalyst composed of chromium hydride entities identifiable as such, which entities are bonded to the surface of an inorganic support and are thermally stable at 400° C., for carrying out the polymerization of olefins.

2. The use as claimed in claim 1, characterized in that the supported chromium hydride entities of the catalyst employed represent at least 10% of the chromium-based entities present at the surface of the inorganic support of the catalyst.

3. The use as claimed in claim 1 or as claimed in claim 2, characterized in that the inorganic support to which the chromium hydride entities are bonded comprises at least one metal oxide.

4. The use as claimed in claim 3, characterized in that the inorganic support to which the chromium hydride entities are bonded is composed of silica, of alumina, of niobium oxide or of silica/alumina.

5. The use as claimed in one of claims 1 to 4, characterized in that the chromium hydride entities present at the surface of the support are in the form of hydrides corresponding to the general formula (A):
(support-)ₙ-Cr—(H)ₘ (A)
in which:
n represents an integer equal to 1, 2, 3 or 4; and
m represents an integer equal to 1, 2 or 3, the sum of m and n being less than or equal to 6.

6. The use as claimed in any one of claims 1 to 5, characterized in that the chromium-based entities present at the surface of the support are essentially chromium hydrides of identical nature.

7. The use as claimed in one of the preceding claims, characterized in that the supported chromium hydride entities are essentially in the form of chromium(IV) hydride of formula:
(silica-)₃-Cr—H

8. The use as claimed in any one of claims 1 to 8, characterized in that the chromium hydride entities present at the surface of the catalyst are obtained by treatment with hydrogen or a hydrogen or alkyl transfer agent of chromium-based entities absorbed beforehand on the support.

9. The use as claimed in any one of claims 1 to 8, characterized in that the supported chromium hydride entities are obtained from supported chromium-based entities of formula (B):
(support-)ₙ₁-Cr—(X)ₙ₂ (B)
in which:
n1 and n2 are two non-zero integers such that the sum (n1+n2) is equal to 2, 3, 4, 5 or 6,
X represents a C₁-C₈ alkyl, C₁-C₈ alkylsilyl, C₁-C₈ allyl or silyl group, a carbonyl, amide, carbene, carbyne, carboxylate, acetylacetonate (acac), imido, cyclopentadienyl, neophyl, benzyl, phenyl, oxo, alkoxide, phosphine, nitrosyl or —CH₂—(CPhMe₂) derivative, the alkoxide derivative optionally comprising a silicon atom, or a metal selected from chromium, molybdenum, tungsten or one of their derivatives.

12. The use as claimed in claim 11, characterized in that X represents a C₁-C₈ alkyl group, a C₁-C₈ alkylsilyl group, a C₁-C₈ allyl group, a cyclopentadienyl group, a carbene group or a carbyne group.

13. The use as claimed in one of claims 8 to 12, characterized in that the catalyst used is obtained by hydrogenolysis of tris[(methyl(trimethylsilyl)]-chromium(IV) entities supported on silica, of formula:
≡(Si—O—)Cr(CH₂Si(CH₃)₃)₃.

14. A process for the polymerization of olefins, comprising a stage in which olefin monomers are brought into contact with a catalyst comprising chromium hydride entities identifiable as such, which entities are bonded to the surface of an inorganic support and are thermally stable at 400° C.

15. The process for the polymerization of olefins as claimed in claim 14, characterized in that the catalyst employed is a catalyst as defined in any one of claims 1 to 13.

16. The process for the polymerization of olefins as claimed in claim 14 or as claimed in claim 15, characterized in that the catalyst is brought directly into contact with a gas stream of the olefin monomers.

17. The process for the polymerization of olefins as claimed in any one of claims 14 to 16, characterized in that the polymerization reaction is carried out in the presence of hydrogen.

18. The process for the polymerization of olefins as claimed in any one of claims 14 to 17, characterized in that the olefins employed are olefins which comprise from 2 to 10 carbon atoms and which are optionally functionalized and in that the polymerization reaction is carried out at a temperature of between −20 and 400° C.

19. The process for the polymerization of olefins as claimed in any one of claims 14 to 17, characterized in that the olefins employed are optionally functionalized olefins comprising from 10 to 100 carbon atoms and in that the polymerization reaction is carried out at a temperature which can reach 400° C.

20. The process for the polymerization of olefins as claimed in one of claims 14 to 17, characterized in that the olefins employed are composed of a mixture of olefins comprising at least one olefin having from 2 to 10 carbon atoms and at least one olefin comprising from 10 to 100 carbon atoms.

21. The process for the polymerization of olefins as claimed in claim 20, characterized in that the olefins employed are composed of a mixture of olefins comprising at least one olefin having from 2 to 10 carbon atoms and at least one functional olefin exhibiting one or more functional groups of acrylate, methacrylate, nitrile, ester, amide and/or anhydride type.
